(19) United States
(12) Patent Application Publication
(10) Pub. No.: US 2026/0102915 A1
(43) Pub. Date: Apr. 16, 2026

(54) SYSTEM AND METHOD FOR TELEOPERATING ROBOTS

(71) Applicant: ACCENTURE GLOBAL SOLUTIONS LIMITED, Dublin 4 (IE)

(72) Inventors: Ioannis POLYKRETIS, Oakland, CA (US); Sri Sadhan JUJJAVARAPU, Fremont, CA (US); Lavinia Andreea DANIELESCU, Seattle, WA (US); Sanjoy PAUL, Sugar Land, TX (US)

(73) Assignee: ACCENTURE GLOBAL SOLUTIONS LIMITED, Dublin 4 (IE)

(21) Appl. No.: 18/974,266

(22) Filed: Dec. 9, 2024

(30) Foreign Application Priority Data
Oct. 11, 2024 (EP) 24386117.6

(51) Int. Cl. B25J 9/16

(52) U.S. Cl. CPC B25J 9/1689; B25J 9/163; B25J 9/1661

(57) ABSTRACT

Methods, systems, and computer-readable storage media for teleoperating robots. Input data for performing a task on the robot is received and analyzed to identify the task. Based on the type of task, target objects required, environmental conditions, a channel bandwidth, and a size of data, complexity level is determined. Based on complexity level of the task and available resources, autonomy level is selected. Based on identified task to be performed and selected autonomy level, robot joint configurations are predicted. Based on predicted robot configurations, control commands are generated to the robot for performing the task. By selecting communication path for transmitting control commands based on autonomy level and available resources, the robot is teleoperated using control commands transmitted using selected communication path.

### PRIORITY

The present application claims priority under 35 U.S.C. 119(a)-(d) to European Patent Application number EP 24386117.6, having a filing date of Oct. 11, 2024, the disclosure of which is hereby incorporated by reference in its entirety.

### FIELD OF THE INVENTION

Various embodiments described herein relate generally to robot manipulation and more specifically to systems and methods for teleoperating robots using multimodal dexterous manipulation.

### BACKGROUND

In recent years, the field of robotic teleoperation has gained significant traction, particularly for applications requiring the remote control of robots in hazardous, inaccessible, or distant environments. This approach offers substantial benefits by ensuring the safety of human operators while allowing precise execution of tasks. Teleoperated robotic platforms are increasingly being employed for various maintenance tasks, including visual inspection, screwing, welding, disassembling, and reassembling, especially in environments that pose safety risks to humans. Additionally, robotic teleoperation is finding applications in diverse industries such as healthcare, where it enables teleoperated surgery and rehabilitation, and in rescue operations and maintenance tasks for space exploration and mining.

Despite the advantages, robotic teleoperation faces significant challenges, particularly when it involves controlling multiple degrees of freedom between the local node (robot) and the remote teleoperator. These challenges are further exacerbated by latency and bandwidth constraints, which hinder seamless communication between the robot and the operator. Current solutions often fail to effectively address these issues, leading to operational inefficiencies and increased risks during critical operations, or overuse and eventual exhaustion of available resources.

### SUMMARY

Implementations of the proposed solution are directed toward enhancing robotic teleoperation through the use of two integral components: a Low-Level Planner (LLP) and a High-Level Planner (HLP). The LLP is designed to learn and apply human-like motion dynamics, enabling it to reconstruct movements from limited haptic samples and thereby reducing latency in task execution. The HLP coordinates the actions of the LLP and offers varying levels of autonomy to assist the teleoperator in performing complex manipulation tasks. This solution facilitates improved task performance by mimicking human-like motion dynamics and optimizing task management based on complexity, ensuring efficient execution in a variety of operational contexts.

In general, innovative aspects of the subject matter described in this specification provide a system for managing robotic tasks. The system comprises a processor and memory with instructions that, when executed by the processor, cause the processor to perform several functions. The processor receives input data for performing a task on a robot, where the input data includes at least one of a task description, task requirements, user intent, haptic input, voice data, and prestored instructions. The processor identifies the task to be performed by analyzing the received input data and determines the task's complexity by evaluating factors such as the type of task, target objects, environmental conditions, channel bandwidth, and data size. Based on this complexity assessment, the processor selects an appropriate level of autonomy from several available options. The processor then predicts the robot's joint configurations required for the task, generates control commands comprising these configurations, target trajectories, and objects, and selects a communication path for transmitting the control commands. Finally, the processor transmits the generated control commands to the robot using the selected communication path.

The present disclosure further describes a method for managing the robotic tasks. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 depicts an example environment that may be used to execute implementations of the present disclosure.

FIG. 2 depicts a block diagram representing an example architecture of a robot controlling system in accordance with implementations of the present disclosure.

FIGS. 3A-3C (collectively referred to as FIG. 3) depict exemplary implementations of a plurality of autonomy levels in accordance with implementations of the present disclosure.

FIGS. 4A and 4B (collectively referred to as FIG. 4) depict exemplary implementations of reproducing actions at robot station controller in accordance with implementations of the present disclosure.

FIG. 5 is a block diagram that depicts an exemplary process flow of a motion intent classifier in accordance with implementations of the present disclosure.

FIGS. 6A and 6B (collectively referred to as FIG. 6) depict graphs representing exemplary experimental information module in accordance with implementations of the present disclosure.

FIGS. 7A-7C (collectively referred to as FIG. 7) depict an exemplary mapping of human gestures onto a robotic arm in accordance with implementations of the present disclosure.

FIG. 8 is a flow diagram that presents an example method in accordance with implementations of the present disclosure.

FIG. 9 illustrates a computer system that may be used to implement the robot controlling system.

Like Reference Numbers and Designations in the Various Drawings Indicate Like Elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“Prompt” or the like refers to a submission to an AI model for processing.

“LLM” and the like refers to a large language model, which is an AI model that processes text-based input prompts.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

In robotic control systems, enabling precise and effective remote control of robots may be important for enhancing operational efficiency and flexibility. The ability to remotely manage robotic actions ensures that users can operate robots from a distance, providing both convenience and operational capability in various settings. Despite advances in control technologies, achieving effective remote control while maintaining high performance can be challenging due to complexities in command translation and execution.

Traditional remote controlling methods often rely on direct, manual inputs or fixed command sequences, which can lead to inefficiencies and limited adaptability. These approaches may struggle with real-time adjustments and integrating complex commands, impacting the overall responsiveness and effectiveness of the system.

The present disclosure introduces an improved approach for remote robot control that leverages advanced control commands generated based on predictive models. By integrating these commands with real-time feedback mechanisms, the system facilitates accurate and responsive robot operations. This enables users to efficiently manage robotic tasks remotely, ensuring that the robot performs actions with precision and alignment to the intended commands. Overall, this approach enhances the capability and efficiency of remote robotic control, accommodating dynamic operational requirements and improving user interaction.

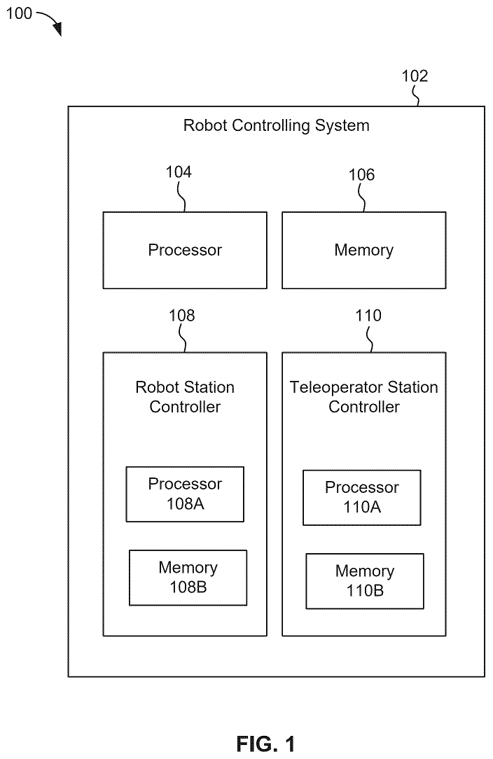

FIG. 1 depicts an example environment 100 that may be used to execute implementations of the present disclosure. In some examples, the example environment 100 enables teleoperation of a robot.

As depicted in FIG. 1, the example environment 100 includes a robot controlling system 102. The term ‘robot controlling system’ 102 refers to a setup or arrangement designed to manage and control the operations of a robot. The robot controlling system 102 integrates various components to enable remote manipulation of robots, particularly in scenarios where direct human presence is impractical or unsafe. The robot controlling system 102 includes a processor 104, and a memory 106.

The processor 104 refers to a computing device that executes instructions to perform operations within the robot controlling system 102. Processor 104 may include components such as microprocessors, microcomputers, or digital signal processors. The processor 104 is responsible for fetching and executing the instructions stored in the memory 106, enabling the system to perform tasks related to robot control.

In some instances, the processor 104 may be implemented as a neuromorphic processor. Neuromorphic processors may refer to specialized computing devices designed to emulate neural processing of a human brain. Neuromorphic processors may utilize parallel processing techniques, allowing for simultaneous execution of multiple tasks. This parallelism may enhance computational efficiency and may reduce power consumption through the integration of memory and processing elements within a single architecture.

The neuromorphic processor may improve dynamic decision-making of the robot controlling system 102. Traditional methods involve creating a static map of the environment through extensive exploration, which can be inefficient in large or outdoor settings. Neuromorphic processors address this inefficiency by enabling real-time adaptive learning. In this regard, a robot equipped with a neuromorphic processor may continuously update its understanding of an environment based on real-time sensory input, eliminating a need for pre-generated static maps.

This allows the robot to make instantaneous navigation decisions, optimizing movement and interaction with its surroundings. For example, when a user input pertains to making a 10 mm incision, the robot controlling system 102 may identify, using the neuromorphic processor, that for user intent of removing a tumor, a 7 mm incision would achieve better results. In such cases, the robot controlling system 102 may, with user approval, make the 7 mm incision, resulting in reduced pain and quick recovery of a patient.

In other instances, the processor 102 may be implemented as a combination of the neuromorphic processor and a general-purpose processor. The neuromorphic processor may be responsible for processing sensory data and making real-time decisions about task performing strategies. Meanwhile, the general-purpose processor may manage secondary functions, such as determining the type of movement (whether random or novelty-based) and executing these movements. This division of tasks leverages strengths of both processors, resulting in reduced latency and improved power efficiency. Therefore, integration of neuromorphic processors in robotic systems provides enhanced decision-making capabilities and operational efficiency, particularly in dynamic and resource-intensive environments. One of ordinary skill in the art will appreciate that the present disclosure may be implemented using any processor capable of executing the features of the present disclosure.

The memory 106 is a storage component that holds data and instructions for the processor 104. It includes processor-executable instructions needed for the robot controlling system 102 to function effectively. The memory 106 stores the information required for various operations, such as managing task requirements and control commands for the robot. The memory 106 is communicably coupled to the processor 104. Further, the memory 106 includes processor-executable instructions which, when executed by the processor, cause the processor to perform a plethora of functions for controlling the robot.

The robot controlling system 102 further includes a robot station controller 108 and a teleoperator station controller 110. The robot station controller 108 refers to a control unit within the robot's environment that manages the processing and execution of commands received from a teleoperator. The robot station controller 108 is responsible for interpreting and implementing instructions required to perform specific tasks using the robot. The robot station controller 108 may utilize bioinspired control algorithms, which mimic the neural processes found in biological organisms to achieve efficient and adaptive control of the robot's movements. Such bioinspired controllers advantageously enable enhanced flexibility and robustness in handling complex tasks, such as manipulating objects with varying shapes or navigating unpredictable terrains.

For example, in a warehouse automation scenario, the robot station controller 108 could be used to manage a robotic arm's movements to pick and place items from shelves, adjusting its grip and motion dynamically based on the size and shape of the objects. An advantage of using a robot station controller with bioinspired algorithms is its ability to adapt to changing environments and tasks, making the robot controlling system 102 more versatile and capable of handling a wider range of operations with higher precision and efficiency.

The robot station controller 108 comprises a processor 108A and a memory 108B. The memory 108B is communicably coupled to the processor 108A. The memory 108B comprises processor-executable instructions which may be executed by the processor 108A to perform actions pertaining to the robot station controller 108. The robot station controller 108 may also comprise further components (not shown here). In some instances, the processor 108A may be implemented as the neuromorphic processor.

The teleoperator station controller 110 refers to a control unit located within the teleoperator's environment, responsible for sending control commands and receiving feedback from the robot station controller 108. This controller allows a human operator (teleoperator), or another controlling system to remotely manage and supervise the robot's actions, enabling tasks to be performed from a distance. The teleoperator station controller 110 processes input data, such as haptic inputs, voice commands, or pre-stored instructions, and converts them into control commands that the robot can execute. It also processes feedback from the robot, such as sensor data or status updates, to refine and adjust the commands, as necessary.

An example of the teleoperator station controller 110 in action is in telemedicine, where a surgeon could remotely control a robotic surgical system using haptic feedback to perform delicate operations. The teleoperator station controller 110 translates the surgeon's hand movements into precise commands for the robot, ensuring high accuracy and control. The advantage of using the teleoperator station controller 110 is the ability to perform complex or dangerous tasks remotely, reducing the risk to human operators and allowing access to locations or situations that may be hazardous or otherwise inaccessible.

The teleoperator station controller 110 comprises a processor 110A and a memory 110B. The memory 110B is communicably coupled to the processor 110A. The memory 110B comprises processor-executable instructions which may be executed by the processor 110A to perform actions pertaining to the teleoperator station controller 110. The teleoperator station controller 110 may also comprise further components (not shown here). In some instances, the processor 110A may be implemented as a general-purpose processor.

The processor 104, the memory 106, the robot station controller 108, and the teleoperator station controller 110 work in tandem to perform functions of the robot controlling system 102. The robot station controller 108 and the teleoperator station controller are communicably coupled to each other, and the processor 104. This interconnectivity ensures seamless communication and coordination between the components, facilitating smooth and efficient operation of the robot controlling system 102.

The processor 104 receives an input data for performing a task on a robot. The input data may be received from a user of the robot controlling system 102. In some instances, the input data may be received from the user via the teleoperator station controller 110. The input data may be implemented as at least one of haptic information about the task, voice commands for the task, textual inputs pertaining to the task, and the like. For example, in an industrial setting, input data might specify the exact path a robot should take to weld a scam or apply paint. The processor 104 then interprets this data to identify the specific task to be performed, ensuring that the robot can execute complex tasks accurately and efficiently.

The input data comprises at least one of a task to be performed, task requirements, a user intent, a haptic input, a voice data, and a prestored instruction. The task to be performed refers to an action or set of actions that the system or user is required to execute to achieve a specific goal or objective. For example, in a robotic surgical system, the task to be performed may involve accurately maneuvering the robotic arm to remove a tumor from a specific area within a patient's body. Here, the robot controlling system 102 must enable the robot at the robot station controller 108 to perform a series of delicate movements to ensure that the tumor is removed without damaging surrounding healthy tissue, thus meeting the high standards for precision and control.

Task requirements describe the specific conditions, constraints, or standards that must be met for the successful completion of a task. For instance, when performing a robotic-assisted surgery to extract a foreign object from a patient's body, the task requirements may include ensuring that the object is grasped and removed without causing any harm to nearby organs. The robot controlling system 102 must ensure that the robot replicates the commands from the teleoperator station controller 110 accurately to achieve the desired outcome while maintaining patient safety.

User intent represents the underlying purpose or goal that a user aims to achieve through their interactions with a system or device. For example, if a surgeon uses the teleoperator station controller 110 with the intent to “perform a precise incision in the abdominal area,” the user intent may be to have the robot execute the incision with exacting accuracy. The robot controlling system 102 must interpret this intent and replicate the movements at the robot station controller 108 to meet the precise specifications required for the surgical procedure.

Haptic input refers to data points from the actions the user (human) is making at the teleoperator station controller 110, which are then replicated by the robot at the robot station controller 108. For instance, if the user manipulates the controls at the teleoperator station controller 110 to guide the robotic arm, the haptic input may include positional data and movement vectors that the robot controlling system 102 uses to adjust the robot's actions at the robot station controller 108.

Voice data pertains to audio information captured from spoken language, used for processing commands, controlling devices, or interacting with systems. In accordance with the above example, in the surgical setting, the voice data may include commands such as “perform a standard incision.” The robot controlling system 102 may process this voice data as an alternative to haptic input, executing pre-stored actions or gestures at the robot station controller 108 to facilitate the procedure. In this regard, the robot controlling system 102 may process the voice data to identify an underlying human intent via the teleoperator station controller 110 and generate robot actions based on the human intent.

In some instances where loss of information is observed, such voice data or voice inputs may be provided by the user/teleoperator to bridge gaps in robot movement. In such instances, a conversational interface associated with the robot controlling system 102 may be utilized to prompt the user for additional (i.e., missing) information. The conversational interface may also be utilized when the human intent is identified as ambiguous, or missing information.

Prestored instruction is a predefined command or set of commands saved in the system's memory, used to automate tasks, or provide consistent responses. For example, a robotic surgical system may have a prestored instruction to “perform a standard appendectomy procedure.” The robot controlling system 102 may execute this prestored instruction by replicating the commands at the robot station controller 108, ensuring that the procedure is carried out consistently and accurately based on previously programmed standards and protocols.

Upon receipt, the processor 104 analyzes the input data to identify the task to be performed on the robot. This analysis involves understanding the type of task, the target objects involved, and any specific requirements or constraints. For example, if the task is to assemble a piece of machinery, the processor 104 will identify the components needed and the order in which they must be assembled. This step is critical for ensuring that the robot controlling system 102 can plan and execute tasks effectively, avoiding errors and optimizing performance.

The processor 104 then determines the complexity level of the task to be performed. In some instances, the complexity level may be provided by the user via the teleoperator station controller 110. The complexity level of the task may be determined based on various factors, including the type of task, nature of the target objects, environmental conditions, available communication bandwidth, and size of the data involved. For example, a simple task like moving an object from one place to another might be classified as low complexity, while a task requiring fine manipulation of small parts in a cluttered environment might be classified as high complexity. Understanding the complexity level helps the robot controlling system 102 allocate resources appropriately and select the most suitable control strategies for the task.

The type of task refers to the specific category or nature of the action or operation that needs to be performed by the robot. For example, in a robotic surgery scenario, the type of task may involve precise tissue manipulation or incision. The nature of the target objects describes the characteristics or properties of the objects that are the focus of the task, such as their material, shape, or functionality. In the context of robotic surgery, the target objects may include delicate tissues or surgical instruments that require careful handling.

Environmental conditions pertain to the external factors or surroundings that may affect the performance or execution of the task, including factors like temperature, lighting, or atmospheric pressure. For instance, surgical procedures may be performed under controlled temperature and lighting conditions to ensure optimal outcomes. Available communication bandwidth refers to the maximum rate at which data can be transmitted between systems or components, impacting the speed and efficiency of data exchange. The size of the data involved refers to the volume or amount of data that needs to be processed, transmitted, or stored in relation to the task or operation. In robotic surgery, this may include extensive data related to the robot's movements, sensor readings, and patient information, which must be efficiently managed to ensure precise and accurate performance.

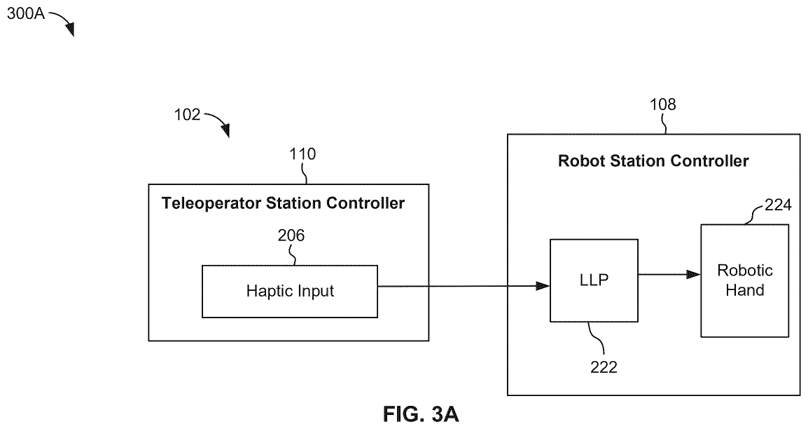

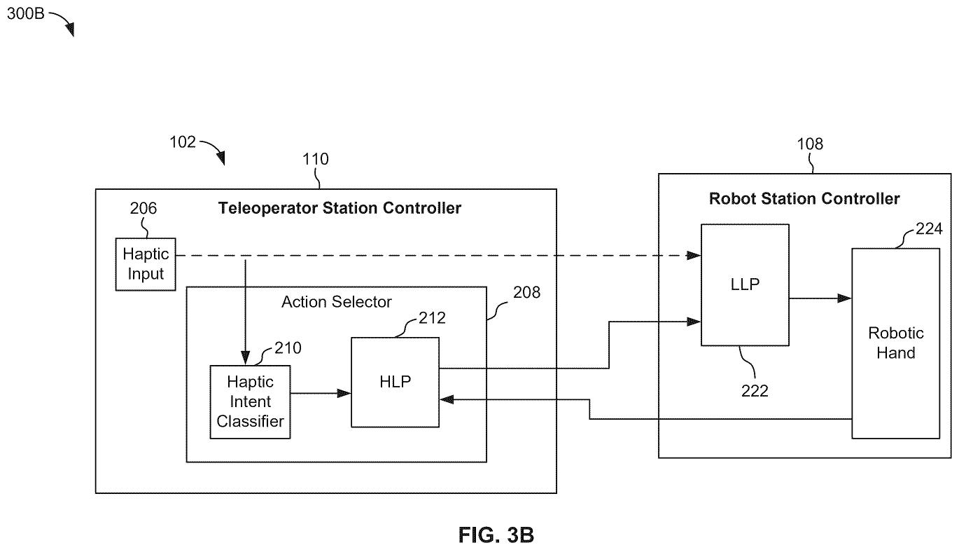

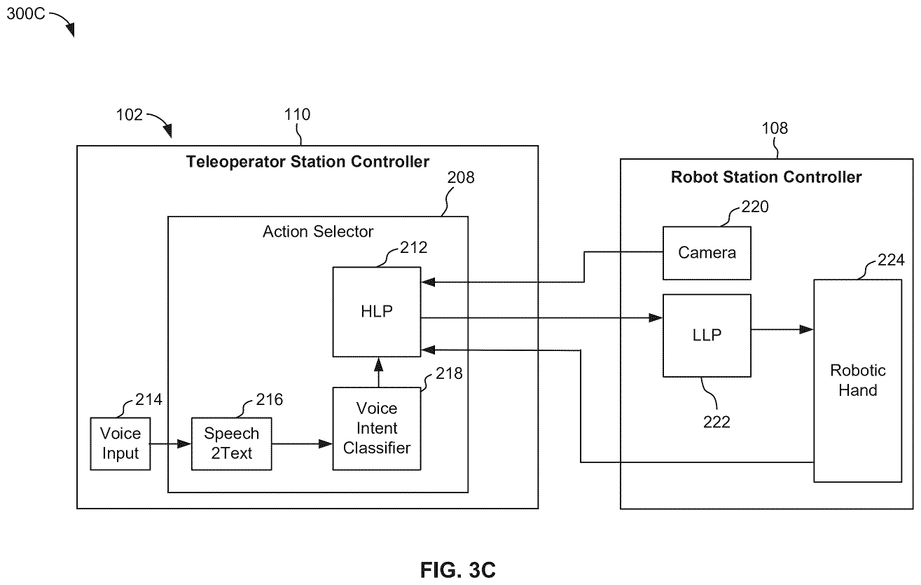

Based on the determined complexity level and the available resources, the processor 104 selects an autonomy level from a plurality autonomy levels for completing the task. The autonomy level refers to an extent to which the robot is capable of executing tasks with varying degrees of independence from human intervention. Autonomy levels may vary from fully manual control, where the teleoperator directs every action, to fully autonomous operation, where the robot executes tasks with minimal human intervention. For instance, in a highly controlled environment with predictable tasks, the robot may operate autonomously, reducing the need for constant human oversight. In contrast, in a dynamic or uncertain environment, higher levels of human involvement may be required to ensure safety and adaptability. Autonomy levels are discussed in detail with respect to FIG. 3.

Notably, the processor 102 may select the autonomy level based on a complexity of the task which are specified by properties of the communication channel (i.e., the available resources). The available resources refer to at least one of bandwidth, sampling frequency, amount of clutter, and the like. In this way, the processor 104 may select the autonomy level based on the complexity level of the task, available bandwidth, sampling frequency, and the like. In some instances, the autonomy level is selected by the user via the conversational interface. In this regard, the user may provide the autonomy level as a hyperparameter.

The processor 104 predicts robot joint configurations needed to perform the identified task, based on the task and the selected autonomy level. Predicting robot joint configurations involves calculating positions and movements of the robot's joints required to achieve desired actions with respect to performing the task. For example, if the task is to pick up an object, the processor 104 will calculate the angles and movements needed for the robot's arm and gripper to reach the object, grasp it securely, and move it to the desired location.

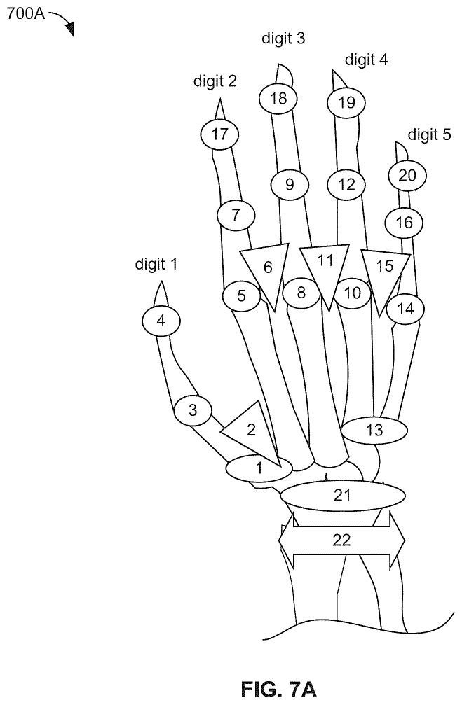

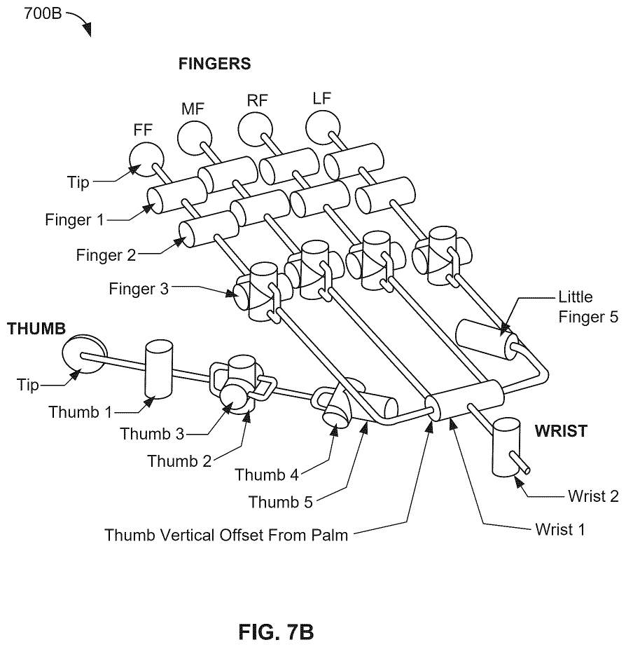

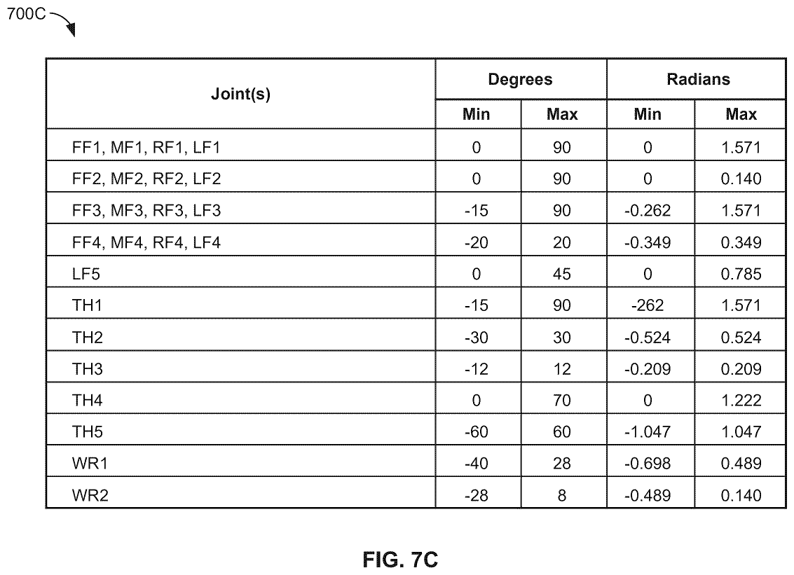

In some instances, the robot joint configuration prediction is based on models of the robot's kinematics and dynamics, as well as the specific requirements of the task. In other instances, the robot joint configuration predictions may be based on degrees of freedom and angles of each joint, pressure, and the like. In such instances, the robot joint configurations are not limited to a specific model or make of the robot and may instead by utilized by any model or make of the robot. This advantageously provides interoperability of the robot controlling system 102 for a plurality of varied robot models. For example, the robot models may be implemented as at least one of: a two-finger gripper, a three-finger gripper, a four-finger gripper, a robotic gripper having multiple degrees of freedom ranging from 2 to 24, an industrial robotic arm, and a collaborative robotic arm. Exemplary representations of the robot joint configurations are iterated with respect to FIG. 7 (specifically, FIG. 7C).

Once the robot joint configurations are predicted, the processor 104 generates control commands for the robot to perform the task. The control commands refer to the instructions generated by the processor to guide the robot in executing the task. The control commands include information pertaining to the task, for example, the predicted robot joint configurations, target trajectories, and target objects, ensuring that the robot's movements are precise and coordinated. For example, in an automated packaging system, the control commands may specify the exact path and actions a robotic arm should follow to pick up items from a conveyor belt and place them into boxes.

The processor 104 generates the control commands based on the predicted joint configurations using one or more command generation techniques. These techniques may include at least one of an inverse kinematics technique, a trajectory planning technique, a motion control technique, a feedback control technique, and the like. The inverse kinematics technique involves using kinematics to convert the predicted joint configurations into specific control commands that the robot's actuators can follow. The trajectory planning technique involves generating a path and timing for the robot's movements, which are then translated into control commands. The motion control technique converts the predicted joint configurations into actuator commands to ensure accurate task performance. The feedback control technique adjusts the control commands based on real-time data from the robot's sensors to correct any discrepancies between predicted and actual joint configurations.

Thereafter, the processor 104 selects a communication path for transmitting the generated control commands to the robot. The communication path refers to a specific route used for transmitting data between the processor 104 (in operation, the user/teleoperator) and the robot. The communication path encompasses channels and protocols through which control commands and other data are sent to the robot. For example, the communication path may be implemented as at least one of a wired Ethernet connection, a wireless network, a dedicated communication link. Selection of the communication path is influenced by factors such as the selected autonomy level, which determines a level of user/human interaction, the channel bandwidth, which affects data transmission speed, and the size of the data, which impacts required data handling capacity. For instance, a high-bandwidth communication path might be selected for real-time control commands in an industrial automation setting, while a lower-bandwidth path could be sufficient for less time-sensitive data in a research application. Advantageously, selecting an appropriate communication path ensures efficient communication and minimizes latency in the robot's actions.

The processor 104 selects the communication path for transmitting the control commands based on the selected autonomy level, channel bandwidth, and size of the data, using one or more path selection techniques. These techniques may include at least one of a path optimization technique, a bandwidth management technique, an adaptive communication technique, a load balancing technique, and the like. The path optimization technique involves evaluating different routes to determine a most efficient communication path based on latency, bandwidth, and reliability requirements. The bandwidth management technique ensures that critical data receives priority by allocating sufficient bandwidth to the same. The adaptive communication technique dynamically adjusts the communication path based on real-time network conditions and data size, optimizing data transfer efficiency. The load balancing technique distributes data across multiple communication paths to prevent overload and enhance overall performance. The application of these path selection techniques ensures that the selected communication path is optimal for reliable and efficient transmission of control commands to the robot.

In some instances, the communication path, once selected, is utilized for completion of any task, and a new communication path may thereafter be selected for another task. In other instances, the user may select the communication path as part of task specification.

By optimizing the communication path, the robot controlling system 102 can reduce the time it takes for commands to reach the robot and for feedback to be received, enabling faster and more responsive operation. For example, in a real-time teleoperation scenario, a high-bandwidth, low-latency communication path might be chosen to ensure smooth and accurate control of the robot.

The processor 104 transmits the generated control commands to the robot using the selected communication path. The generated control commands may be transmitted to the robot via the robot station controller 108. This transmission allows the robot to receive and execute the commands, performing the task as intended.

The robot station controller 108 receives the generated control commands from the teleoperator station controller 110 of the robot controlling system 102. In operation, the robot station controller 108 receives the generated control commands from the teleoperator station controller 110 via the processor 104.

The robot station controller 108 configures robot joint angles based on the received control commands. The robot joint angles refer to specific angles at which joints of a robotic arm or manipulator are positioned relative to their respective axes. These angles determine a configuration of the robot's arm and may be important for specifying a position and/or orientation of the robot's end effector (e.g., gripper, tool) in the robot's environment. The joint angles are essential parameters for controlling the robot's movement and ensuring accurate execution of tasks. For example, in a robotic arm with multiple joints, the joint angles would specify how each joint is rotated to achieve a desired end-effector position, such as reaching out to grasp an object or performing a precise cut.

The received control commands may comprise the predicted robot joint configurations, the target objects, and the target trajectories. The robot station controller 108 configures the robot joint angles based on the received control commands by reversely applying the command generation techniques initially used by the processor 104 for generating these control commands from the predicted joint configurations. The robot station controller 108 translates the predicted joint configurations specified in the control commands into actual joint angles required for the robot's movements. Techniques such as inverse kinematics, trajectory tracking, and motion control are employed in reverse to achieve this translation. For example, if the control commands specify a particular end-effector position, the robot station controller 108 may utilize the inverse kinematics technique to calculate and configure appropriate joint angles necessary to achieve the particular end-effector position.

Based on the configured robot joint angles, the robot station controller 108 generates human-like motions for the robot. Human-like motions refer to robotic actions that closely mimic the complex and nuanced movements typically performed by a human. These motions include a range of precise, coordinated movements that replicate human dexterity, fluidity, and adaptability in tasks. Human-like motions involve intricate control of joint angles, forces, and trajectories to achieve actions such as delicate gripping, intricate manipulations, and smooth transitions. For example, in the robotic surgical system, human-like motions might involve the precise handling of surgical instruments with a level of finesse and control similar to that of a skilled surgeon, allowing the robot to perform tasks with high accuracy and minimal disruption to surrounding tissues.

The robot station controller 108 also considers the target trajectories and the target objects for generating human-like motions for the robot. In operation, the robot station controller 108 utilizes pre-trained motion dynamic models for generating the human-like motions. The pre-trained motion dynamic models refer to computational models that have been developed and trained on extensive datasets of human motion to accurately predict and replicate complex movements. Such models are designed to capture dynamic characteristics of human motions, such as speed, acceleration, and coordination.

By leveraging machine learning techniques, motion dynamic models are trained on a variety of motion data to learn patterns and behaviors that can then be applied to generate similar motions in a robotic system. For instance, in the context of generating human-like motions, the pre-trained motion dynamic model might be used to simulate the nuanced movement of a human hand, allowing a robot to perform tasks with the same level of dexterity and fluidity observed in human actions when performing surgery. In some instances, the pre-trained motion dynamics models may be trained using at least one of a neuromorphic algorithm, a von-Neumann algorithm, and the like. When the pre-trained motion dynamics models are trained using the neuromorphic algorithm, the neuromorphic algorithm may be executed on at least one of a von-Neumann processor, a neuromorphic processor, and the like. Alternatively, when the pre-trained motion dynamics models are trained using the neuromorphic algorithm, the von-Neumann algorithm may be executed on at least one of the von-Neumann processors, a general-purpose processor, and the like.

The robot station controller 108 generates human-like motions for the robot using pre-trained motion dynamic models by translating predicted human-like movement patterns into control commands that adjust the robot's joint angles and actuators. To generate human-like motions, the robot station controller 108 may input task parameters and end-effector goals into the pre-trained motion dynamic model. The pre-trained motion dynamic model, trained on extensive human movement datasets, predicts the joint angles, trajectories, and velocities required by the robot for performing the task. The robot station controller 108 then translates these predictions into control commands, which adjust the robot's joint angles and actuators accordingly. This approach ensures that the robot's movements closely replicate human dexterity and fluidity, enabling precise manipulation and intricate task execution with smooth, coordinated actions.

Thereafter, the robot station controller 108 performs the task on the robot in alignment with the generated human-like motions. The robot station controller 108 performs the task based on the received input data, the target trajectories, and the selected autonomy level.

The robot controlling system 102 remotely controls the robot using the robot station controller 108 based on the generated control commands. To remotely control the robot using the robot station controller 108, the robot controlling system 102 provides control commands from the teleoperator station controller 110 to the robot station controller 108. These control commands are generated based on the predicted joint configurations or desired actions that need to be performed by the robot. The robot station controller 108 interprets these commands and translates them into actionable instructions that direct the robot's movements and operations.

The robot station controller 108 interfaces with the robot's actuators and sensors to execute the commands. This ensures that the robot's actions align with the intended tasks by adjusting the robot's joints and end-effectors as specified by the control commands. This allows for precise and remote management of the robot's activities, enabling users to perform complex tasks or operations from a distance with accuracy and efficiency. Design and interface of the robot controlling system 102 supports real-time feedback and adjustments, ensuring that the robot's performance closely matches the user's instructions and the operational requirements of the task.

This advantageously enables remote operation of the robot, reducing the need for physical presence and allowing users to manage and control robotic systems efficiently, regardless of their location.

When the processor 104 is implemented as the neuromorphic processor, it may be utilized train the robot for movement (i.e., the robot station controller 108 and the teleoperator station controller 110 may be trained to control movement of the robot). For example, the neuromorphic processor may determine which actions the robot should take. In some instances, the robot station controller 108 and the teleoperator station controller 110 utilize neuromorphic processors. In this regard, neuromorphic processors execute algorithms to perform and control different operations of the robot controlling system 102.

The neuromorphic processors may implement a spiking neural network (SNN). The spiking neural network is an artificial neural network that uses biologically realistic models of neurons to closely imitate natural neural networks. The neuromorphic processors use special-purpose circuitry, e.g., special-purpose machine learning circuits. For example, a neuromorphic research chip, such as Intel's Loihi chip, or a neural network processor, such as BrainChip's Akida™ chip. In such special-purpose circuitry, the neurons may be implemented as hardware neuron cores that output spikes based on voltage or current inputs to the neurons. The spikes may be signals, e.g., messages, sent between neurons and, in some cases, can carry a message payload. A spike represents a voltage signal having a positive voltage level and a short duration, e.g., having a spike width of about 1 millisecond.

When the processor 104 is implemented as the neuromorphic processor, the robot station controller 108 and the teleoperator station controller 110 may be trained using neuromorphic algorithms (or similar other algorithms). The training may comprise two phases: model selection and model evaluation. In this regard, for example, the model selection may be performed in a non-neuromorphic manner. For example, an A* search run on a Von Neumann architecture. The model evaluation may be performed in a neuromorphic manner, for example, utilizing a neuromorphic processor.

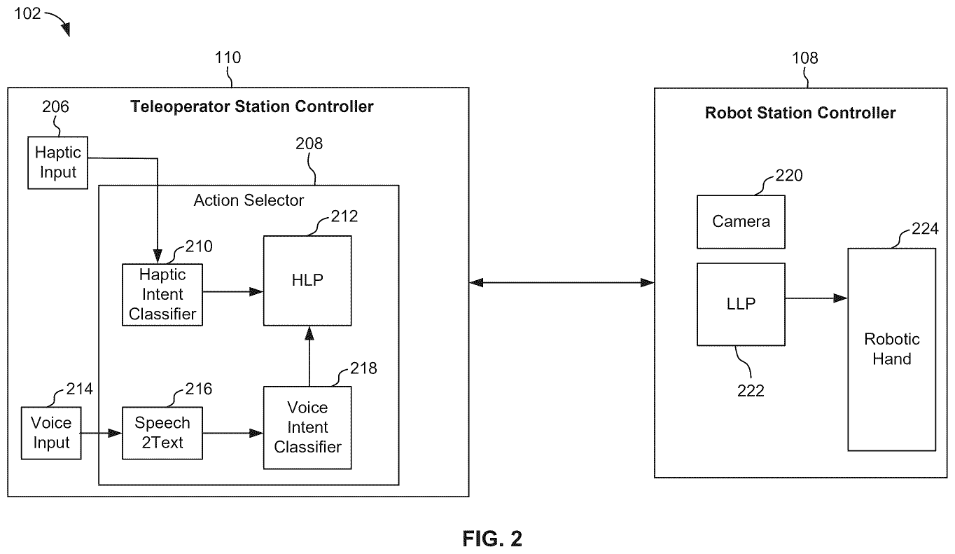

FIG. 2 depicts a block diagram representing an example architecture of a robot controlling system 102 in accordance with implementations of the present disclosure. Specifically, FIG. 2 depicts sub-components and inter-relationships between the robot station controller 108 and the teleoperator station controller 110.

The teleoperator station controller 110 comprises a haptic input 206, a voice input 214, and an action selector 208. The haptic input 206 refers to physical commands from the user, such as gestures or movements, which the teleoperator station controller 110 translates into commands that can be interpreted by the robot. For example, if the user moves a joystick or manipulates a control device, the haptic input 206 records these actions. An advantage of haptic input 206 is that it allows for direct, intuitive control of the robot, enabling precise manipulation of tasks. The voice input 214 refers to spoken commands from the user, which the teleoperator station controller 110 converts into text, and eventually, commands, that the robot can interpret. For instance, if a user issues a verbal command like “rotate the arm,” the voice input 214 records this command. An advantage of voice input 214 is its case of use and ability to handle complex instructions without physical interaction, facilitating hands-free operation.

The action selector 208 processes the inputs from both the haptic input 206 and the voice input 214 to determine the specific tasks to be performed by the robot. The action selector 208 integrates multiple functions to interpret and act upon user commands, including identifying intent and converting voice commands into actionable data. The action selector 208 comprises a haptic intent classifier 210, a high-level planner (HLP) 212, a speech-to-text convertor 216, and a speech intent classifier 218. The haptic intent classifier 210 analyzes the haptic input 206 to determine the user's intent. For example, if the haptic input suggests a specific gesture, the haptic intent classifier 210 interprets this as a command for the robot to perform a corresponding action. The advantage of the haptic intent classifier 210 is that it enables the system to understand and respond to nuanced user inputs accurately.

The HLP 212 generates high-level instructions based on the user intent and task data. It may utilize a hard-wired or learnable joint configuration generator, such as a robot state machine or behavioral tree, to create detailed task plans. For instance, if the task involves assembling components, the HLP 212 determines the necessary robot joint configurations and actions required to complete the assembly. Advantageously, the HLP 212 enables generation of complex task plans and adaption to varying user inputs, ensuring efficient and accurate task execution. In some instances, the HLP is utilized on a general-purpose processor.

The speech-to-text convertor 216 refers to a component which converts voice input 214 into a textual format. For example, if a user says, “may I have a glass of water,” the speech-to-text convertor 216 transforms this spoken command into written text. An advantage of this component is that it enables the system to handle voice commands effectively, translating spoken instructions into a format that can be processed by other system components. The speech intent classifier 218 processes the textual data from the speech-to-text convertor 216 to extract user intent. For example, the speech intent classifier 218 interprets the decoded text and maps it to specific robot actions. This ensures accurate translation of voice commands into actionable instructions, facilitating smooth interaction between the user and the robot.

When the haptic input 206 is provided by the user, the teleoperator station controller 110 forwards this input to the haptic intent classifier 210. The haptic input 206 may include data derived from the user's physical interactions, conveying specific commands or tasks for the robot to perform. The haptic intent classifier 210 processes this haptic data to determine the user's intent by analyzing various characteristics of the input. For example, if the haptic input 206 involves a particular gesture, the haptic intent classifier 210 interprets this as a command for a specific robot action. The identified user intent, along with the haptic input 206, is then provided to the high-level planner (HLP) 212.

Alternatively, when the voice input 214 is provided, it is first processed by the speech-to-text convertor 216, which translates the spoken commands into text. This voice input 214, representing verbal instructions from the user, is converted into textual data that can be further analyzed. The speech intent classifier 218 then interprets this textual input to extract actionable information. For instance, if the voice command is “move the arm to the left,” the speech-to-text convertor 216 will convert this into text, and the speech intent classifier 218 will decode it into specific instructions. The decoded text and the voice input are then sent to the HLP 212.

In each scenario, the HLP 212 operates independently based on a type of input received (for example, the haptic input 206, or the voice input 214). When provided with data from the haptic intent classifier 210 or speech intent classifier 218, the HLP 212 uses this information to generate detailed task plans and control commands specific to the user's instructions. The HLP 212 translates the user intent into precise actions for the robot, ensuring that the robot performs the desired tasks accurately. For example, if the HLP 212 receives instructions to manipulate an object, it will determine the appropriate movements and adjustments needed for the robot to carry out the task effectively.

In some instances, the user may provide conflicting commands via both input modalities. For example, the voice input may be “pick up the glass,” but the haptic input may move away from a direction of the glass. In such instances, the robot controlling system 102 may rely on the haptic input. Alternatively, in such instances, the robot controlling system 102 may disambiguate the conflict. The robot controlling system 102 may disambiguate the conflict by providing prompts and receiving responses from the user to clarify the task. In the present example, the robot controlling system 102 may employ a conversational/speech interface to provide prompt “which glass would you like to pick up”, or “would you like me to perform another action before picking up the glass”. The robot controlling system 102 would receive user responses on the same and alter human intent (as well as other factors) for the task accordingly.

The High-Level Planner (HLP) 212 may be implemented as at least one of a Robot State Machine, a Behavioral Tree, a Neural Network, a Markov Decision Process (MDP), a Finite State Machine (FSM), a Petri Net, a Hierarchical State Machine (HSM), a Dynamic Decision Network (DDN), a Rule-Based System, and the like. The Robot State Machine organizes and transitions between different operational states based on the robot's current status and input conditions. The Behavioral Tree structures tasks hierarchically, with nodes representing actions or conditions and branches illustrating decision paths. The Hierarchical Task Network (HTN) breaks down complex tasks into simpler, manageable sub-tasks arranged in a hierarchical manner. The Petri Net provides a graphical and mathematical model for representing and analyzing concurrent and parallel processes within robotic systems. The Finite State Automaton (FSA) manages discrete, sequential processes with transitions between various states based on inputs and conditions. The Dynamic Decision Network (DDN) offers a framework for probabilistic reasoning, making decisions under uncertainty by evaluating potential outcomes. The Rule-Based System relies on predefined rules to determine actions and responses.

In some instances, the high-level planner (HLP) 212 may utilize combined data from both the haptic input 206 and voice input 214 to generate a comprehensive task plan. The HLP 212 integrates the user intent with the task requirements to create detailed instructions for the robot, which involves mapping the identified user intent to specific robot actions and sequences. The HLP 212 then formulates control commands based on these instructions, ensuring that the robot performs the desired tasks accurately and efficiently.

The robot station controller 108 comprises a camera 220, a low-level planner (LLP) 222, and a robotic hand 224. The camera 220 captures real-time telemetry data to monitor the robot's actions and performance. For instance, it records the robot's movements during an assembly task to ensure that operations are performed correctly. This provides visual feedback, enabling the system to verify task execution and make necessary adjustments based on observed performance. The LLP 222 refers to a bio-inspired adaptive joint controller that refines the high-level instructions from the HLP 212 into precise control commands for the robot. For example, it adjusts the robot's joint movements based on real-time feedback to ensure accurate task performance. An advantage of the LLP 222 is its adaptability and precision, allowing the robot to perform complex tasks with high accuracy.

When the processor 104 is implemented as the neuromorphic processor, the LLP may be implemented as a neuromorphic algorithm run on neuromorphic hardware.

The robot is implemented as the robotic hand 224. The robotic hand 224 represents an implementation of the robot's end-effector, designed to execute various tasks based on control commands. For instance, the robotic hand 224 may be used to manipulate objects or assemble parts. An advantage of the robotic hand 224 is its versatility and capability to perform a wide range of tasks, demonstrating the practical application of the robot controlling system 102. Notably, the robotic hand 224 is one of many possible implementations of the robot, and many other implementations are also feasible.

The robot station controller 108 generates the human-like motions for the robot based on the configured robot joint angles, the target trajectories, and the target objects. In operation, the robot station controller 108 generates the human-like motions by generating a plurality of motion dynamic models corresponding to the configured robot joint angles, the target trajectories, and the target objects.

The motion dynamic models refer to advanced computational frameworks designed to replicate and predict complex human-like movements. These models are developed through extensive training on large datasets of human motion, capturing the intricacies of joint angles, trajectories, and velocities associated with various tasks. In some instances, the motion dynamic models may be pre-trained. The pre-training process involves exposing the model to a wide range of motion data, allowing it to learn and generalize patterns of human movement. Once trained, the model can generate precise predictions of joint configurations and motion dynamics required for the robot to perform tasks with a high degree of dexterity and fluidity. For example, if a robot needs to manipulate delicate objects, the pre-trained motion dynamic model would provide the necessary joint angles and movement trajectories to achieve smooth and accurate handling, closely mimicking human capabilities. This capability enhances the robot's performance by ensuring that its actions are not only effective but also exhibit natural human-like fluidity and coordination.

The plurality of motion dynamic models corresponds to a plurality of bioinspired joint controllers. Bioinspired joint controllers are advanced control systems engineered to emulate the adaptive and responsive characteristics of biological systems in regulating joint movements. These controllers incorporate algorithms and mechanisms that simulate natural processes, such as sensory feedback and motor control, to facilitate real-time adjustments. By dynamically modulating joint stiffness and movement patterns based on sensor input, bioinspired joint controllers enhance the precision and dexterity of robotic systems, thereby improving their capability to execute intricate and delicate tasks. This design closely replicates nuanced control observed in biological entities, resulting in more effective and versatile robotic operations.

The robot station controller 108 determines an optimal performing motion dynamic model from among the plurality of motion dynamic models based on several criteria. Initially, each motion dynamic model is evaluated based on its performance metrics. The performance metrics may include accuracy, computational efficiency, responsiveness to various tasks, and the like. The relevance of each model is thereafter assessed to the configured robot joint angles, ensuring that the model can accurately predict or simulate movements considering the robot's specific joint configurations. For example, the robot station controller 108 may evaluate how well each model predicts or generates target trajectories required for the task, comparing the model's output with the desired movement patterns. The robot station controller 108 may determine the model's effectiveness in interacting with or manipulating the target objects, considering factors such as the objects' physical properties. By combining these evaluations, the processor ranks the models according to their suitability, selecting the model that best aligns with the robot's joint angles, desired trajectories, and interaction requirements for the target objects.

Thereafter, the robot station controller 108 generates the human-like motions for the robot based on the determined optimal performing motion dynamic model. In operation, task parameters and end-effector goals are inputted into the determined optimal performing motion dynamic model. The model, having been determined to perform optimally, predicts necessary joint configurations, trajectories, and velocities required to execute the task with human-like precision. Based on these predictions, the robot station controller 108 translates the predicted joint configurations into control commands, which are used to adjust the robot's actuators and joints. Consequently, the robot performs the task with movements that closely replicate human dexterity and fluidity, enabling it to undertake complex and delicate operations with high accuracy and smoothness.

In some instances, the robot station controller 108 tunes the human-like motions for the robot based on the configured robot joint angles, the target trajectories and the target objects using pre-trained motion dynamic models. This involves using the pre-trained models to adjust and optimize (i.e., tune/fine-tune) the robot's movements to ensure they align with the precise angles and paths required for the task. By inputting the configured parameters into the pre-trained models, the robot station controller 108 evaluates and adjusts the motions to achieve the desired precision and coordination.

FIG. 3 depicts exemplary implementations of a plurality of autonomy levels 300A, 300B, and 300C in accordance with implementations of the present disclosure. The plurality of autonomy levels for completing the task comprises one of a minimal autonomy level, a moderate autonomy level, and a maximal autonomy level. Each of the minimal autonomy level, the moderate autonomy level, and the maximal autonomy level are described in detail with respect to FIGS. 3A, 3B, and 3C, respectively.

In some instances, the robot controlling system 102 selects the autonomy level based on the task. However, in other instances, the user may specify the autonomy level as a hyperparameter when communicating action related inputs (for example, haptic or voice inputs) to the robot controlling system 102.

FIG. 3A depicts an exemplary implementation of the minimal autonomy level 300A in accordance with implementations of the present disclosure.

The minimal autonomy level refers to a mode of operation where the robot requires direct input from the user for each command. In this level, all commands are provided by the user through haptic input 206 at the teleoperator station controller 110, with the robot executing actions based solely on these direct commands without intermediate processing or system-generated modifications.

As shown in the figure, the robot controlling system 102 comprises the teleoperator station controller 110 and the robot station controller 108. The teleoperator station controller 110 comprises the haptic input 206. The robot station controller 108 comprises the LLP 222 and the robotic hand 224.

In operation, for the minimal autonomy level 300A, the user provides the haptic input 206 via the teleoperator station controller 110. The teleoperator station controller 110 receives the input data as the haptic input 206 from the user for performing the task on the robot. The autonomy level is selected as the minimal autonomy level 300A for completing the task using the robot based on the received haptic input 206. The teleoperator station controller 110 sparsely samples the haptic input 206. Further, the haptic input 206 is transmitted to the robot using the selected communication path.

Since the teleoperator station controller 110 is communicably coupled to the robot station controller 108, the haptic input 206 (and the sparse samples thereof) is provided to the LLP 222. As previously discussed, the LLP 222 comprises the plurality of pre-trained motion dynamic models (i.e., biologically realistic controller architectures) which have been pre-trained on motion dynamics of human joints. Due to the motion dynamic models, the LLP 222 interpolates the sparse samples of the haptic input 206 into human-like joint motions. The LLP 222 provides commands to the robotic hand 224 for executing the human-like joint motions.

FIG. 3B depicts an exemplary implementation of the moderate autonomy level 300B in accordance with implementations of the present disclosure.

The moderate autonomy level refers to a mode of operation where the robot controlling system 102 processes user commands at the teleoperator station controller 110. In this level, haptic inputs 206 from the user are first processed to determine the user's intent, post which the robot station controller 108 generates control commands for the robot. This allows for some level of autonomous decision-making and command refinement by the robot controlling system 102 based on the processed input.

As shown in the figure, the robot controlling system 102 comprises the teleoperator station controller 110 and the robot station controller 108. The teleoperator station controller 110 comprises the haptic input 206 and the action selector 208. The action selector 208 comprises the haptic intent classifier 210 and the HLP 212. The robot station controller 108 comprises the LLP 222 and the robotic hand 224.

In operation, for the moderate autonomy level 300B, the user provides haptic input 206 via the teleoperator station controller 110. The teleoperator station controller 110 receives the input data as the haptic input 206 from the user for performing the task on the robot. The task to be performed on the robot is determined by analyzing the received haptic input 206. Further, the complexity level of the task to be performed is determined by analyzing the type of the task to be performed, the target objects required, the environmental conditions, the channel bandwidth, and the size of data. The autonomy level is selected as the moderate autonomy level 300B for completing the task using the robot based on the determined complexity level of the task and available resources.

The action selector 208 processes this haptic input 206 to classify the user's motion intent using the haptic intent classifier 210. The haptic intent classifier 210 may also be referred to as an artificial intelligence-based motion intent model. The haptic intent classifier 210 classifies the determined user intent into at least one motion type based on the received haptic inputs and a pre-stored motion table. The pre-stored motion table refers to a table or index of pre-stored information having human gestures along with respective joint configurations. The haptic intent classifier 210 identifies the user intent by cross-referencing the haptic input 206 with the human gestures and respective joint configurations from the pre-stored motion table.

The haptic intent classifier 210 then relays this classified motion intent to the HLP 212. The HLP 212 refines the motion intent and determines the necessary joint configurations. In this regard, the HLP 212 generates missing joint configurations for performing the task by mapping the classified motion type to pre-stored joint configurations. The HLP 212 may map the classified motion to the pre-stored joint configurations using at least one of the robot state machines, the robot behavioral tree, and the like.

Thereafter, the HLP 212 generates control commands to the robot for performing the task based on the generated missing joint configurations. The control commands comprise the missing joint configurations, the target trajectories, and the target objects. Further, the HLP 212 selects a communication path for transmitting the generated control commands to the robot based on the moderate autonomy level 300B, the channel bandwidth, and the size of the data.

On selecting the communication path, the generated control commands are sent to the robot using the selected communication path. Specifically, the generated control commands (i.e., configurations) are subsequently transmitted to the robot station controller 108. At the robot station controller 108, the LLP 222 utilizes its pre-trained motion dynamic models to interpolate the joint configurations into human-like motions. The LLP 222 then generates control commands based on these interpolated motions, which are sent to the robotic hand 224 to perform the human-like motions.

FIG. 3C depicts an exemplary implementation of the maximal autonomy level 300C in accordance with implementations of the present disclosure.

The maximal autonomy level 300C refers to a mode of operation where the robot controlling system 102 operates with minimal direct user intervention. At this level, the user provides commands solely through voice input 214, which are processed by the teleoperator station controller 110. The robot controlling system 102 then translates these voice commands into control commands for the robot, leveraging its full autonomy to perform tasks based on the interpreted voice instructions.

As shown in the figure, the robot controlling system 102 comprises the teleoperator station controller 110 and the robot station controller 108. The teleoperator station controller 110 comprises the voice input 214 and the action selector 208. The action selector 208 comprises the speech-to-text convertor 216, the speech intent classifier 218, and the HLP 212. The robot station controller 108 comprises the camera 220, the LLP 222 and the robotic hand 224.

In operation, for the maximal autonomy level 300C, the user provides voice input 214 via the teleoperator station controller 110. The teleoperator station controller 110 receives the input data as at least one of the text data (not shown) and the voice input 214 from the user for performing the task on the robot. The task to be performed on the robot is identified by analyzing the received voice input 214. The text data would be translated into control commands for the robot by the robot controlling system 102. Further, the complexity level of the task to be performed is determined by analyzing the type of the task to be performed, the target objects required, the environmental conditions, the channel bandwidth, and the size of data. The autonomy level is selected as the maximal autonomy level 300C for completing the task using the robot based on the determined complexity level of the task and available resources.

The received voice input 214 is converted into text-based actions to be performed by the robot for completing the task. Specifically, the speech-to-text convertor 216 processes this voice input 214 to convert it into the text-based actions. The speech intent classifier 218 then extracts the target object and action from the text, translating the voice commands into high-level actions. These high-level actions are further processed by the HLP 212. The HLP 212 detects the target objects in a field of view of the robot, based on the converted text-based actions using the vision foundational model. Additionally, the HLP 212 detects at least one of the robot state machines, the robot behavioral tree, and the like, based on the converted text-based actions.

The HLP 212 generates the target trajectories for the detected target objects based on the robot state machine, the robot behavioral tree and the converted text-based actions. Based on the generated target trajectories, the HLP 212 predicts the robot joint configurations for performing the task by mapping the text-based actions to the generated target trajectories using a generative artificial intelligence model and a machine learning model.

Thereafter, the HLP 212 generates control commands to the robot for performing the task based on the predicted robot joint configurations. The control commands comprise the predicted robot joint configurations, the target trajectories, and the target objects. Further, the HLP 212 selects a communication path for transmitting the generated control commands to the robot based on the maximal autonomy level 300C, the channel bandwidth, and the size of the data.

On selecting the communication path, the generated control commands are sent to the robot using the selected communication path. Specifically, the generated control commands (i.e., configurations) are subsequently transmitted to the robot station controller 108. At the robot station controller 108, the LLP 222 utilizes its pre-trained motion dynamic models to interpolate the joint configurations into human-like motions. The LLP 222 then generates control commands based on these interpolated motions, which are sent to the robotic hand 224 to perform the human-like motions.

The robot controlling system 102 can thus perform tasks autonomously, with minimal inputs from the user. In some instances, the maximal autonomy level 300C may be overridden by the user (i.e., operator) through use of the haptic input 206 whenever it is deemed necessary to adjust or correct the robot's actions.

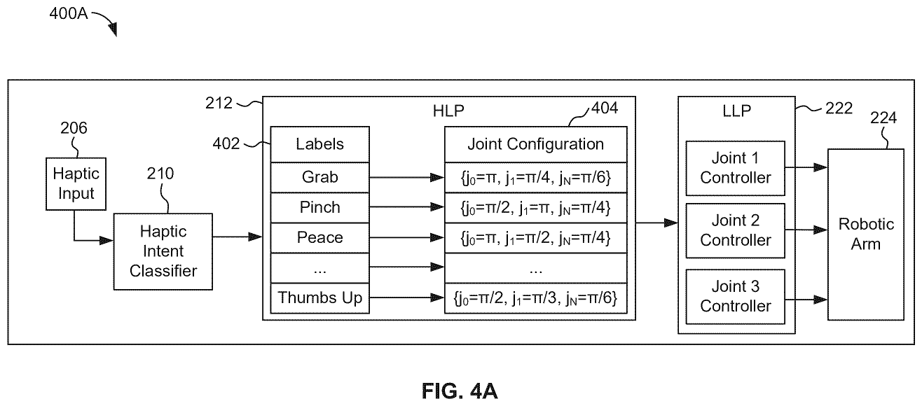

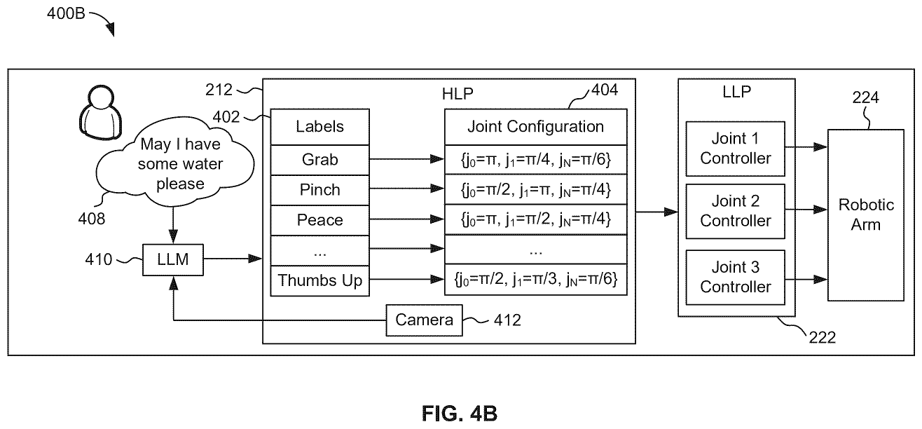

FIG. 4 depicts exemplary implementations 400A, 400B of reproducing actions at the robot station controller in accordance with implementations of the present disclosure.

FIG. 4A depicts an exemplary implementation 400A of reproducing actions at the robot station controller for a moderate autonomy level, in accordance with implementations of the present disclosure.

On being received from the user, the haptic input 206 is provided to the haptic intent classifier 210. The haptic intent classifier 210 identifies the user intent from the haptic input 206.

The haptic input 206 and the user intent is thereon provided to the HLP 212. The HLP 212 comprises a pre-stored motion table, having pre-stored actions (pertaining to human gestures) along with their respective joint configurations.

As shown in the figure, the pre-stored actions are stored as labels 402 and respective joint configurations are stored under joint configuration 404. For example, the pre-stored action of ‘grab,’ has respective joint configurations {j₀=π, j₁=π/4, j_{N}=π/6}. The HLP 212 maps the haptic input 206 with the pre-stored motion table. In this way, the HLP 212 saves processing time by directly fetching relevant joint configurations stored in the pre-stored motion table instead of processing each action/motion. On mapping, the HLP 212 identifies missing joint configurations which are not stored in the pre-stored motion table.

Thereafter, the HLP 212 generates control commands for the robot to perform the task. The control commands are generated based on the missing joint configurations. The HLP 212 interpolates joint configurations of the haptic input 206 from known joint configurations (i.e., joint configurations extracted from the pre-stored motion table). In this way, the HLP 212 accurately predicts the joint configurations, which are transformed into robot-understandable instructions to generate the control commands.

The HLP 212 provides the control commands to the LLP 222. The LLP 222 comprises joint controllers for each joint of the robotic arm 224. For example, joint 1 controller may pertain to a first joint in the first finger of the robotic arm 224, joint 2 controller may pertain to a second joint in the thumb of the robotic arm 224, and joint 3 controller may pertain to a third joint in the wrist of the robotic arm 224.

Hence, the LLP 222 provides individual control commands pertaining to the configuration of each joint to the respective joint controller. The respective joint controllers, thereby, execute individual joint configurations onto respective joints of the robotic arm 224. In this way, the robotic arm 224 performs actions associated with the task, thereby performing the task.

FIG. 4B depicts an exemplary implementation 400B of reproducing actions at the robot station controller for a maximal autonomy level, in accordance with implementations of the present disclosure.

Upon receiving a voice command 408, such as ‘May I have some water please?’, the voice command 408 is transmitted to the LLM 410. The LLM 410, or Large Language Model, is a sophisticated system designed to interpret and analyze the voice command to determine the specific task to be performed by the robot. The LLM 410 evaluates the voice command to extract pertinent task details, including the type of task, the target objects needed, environmental conditions, channel bandwidth, and data size. This information is subsequently communicated to the HLP 212.

In some instances, a conversational module may be utilized instead of the LLM 410. The conversational module may identify an intent pertaining to the task, as well as associated parameters from the intent. In some instances, the conversational module may utilize rule-based, a combined rule-based, or a statistical technique for identifying the intent. In some instances, the technique may be selected based on an acceptable level of error for performing the task. For example, an LLM may have a highest likely error, a statistical model which is not an LLM would have slightly less error, and a rule-based model may have a lowest likely error. The HLP 212, which includes a speech-to-text convertor (not shown in this figure), converts the received voice command 408 into text. The HLP 212 is further equipped with a camera 412 that captures environmental information within the robot's vicinity. This environmental information/data is utilized by the HLP 212 to detect target objects present in the field of view of the robot.

Utilizing the information about detected target objects, the HLP 212 generates target trajectories required for the task. The HLP 212 comprises the pre-stored motion table, having pre-stored actions (pertaining to human gestures) along with their respective joint configurations. As shown in the figure, the pre-stored actions are stored as labels 402 and respective joint configurations are stored under joint configuration 404.

The HLP 212 maps the text-based actions derived from the voice command 408 to these target trajectories. By comparing the generated trajectories with pre-stored motion tables, the HLP 212 predicts the necessary robot joint configurations. Based on these predicted joint configurations, the HLP 212 generates the control commands.

The control commands are provided to the LLP 222, which comprises joint controllers for each joint of the robotic arm 224. The LLP 222 processes these commands, with each joint controller responsible for a specific joint in the robotic arm 224. For example, the joint controller for the first joint may control the index finger, while the joint controller for the second joint may manage the thumb.

Accordingly, the LLP 222 issues individual control commands to each joint controller, which then executes the joint configurations on their respective joints of the robotic arm 224. This coordinated action allows the robotic arm 224 to accurately perform the task as specified by the voice command, ensuring effective and precise task execution.

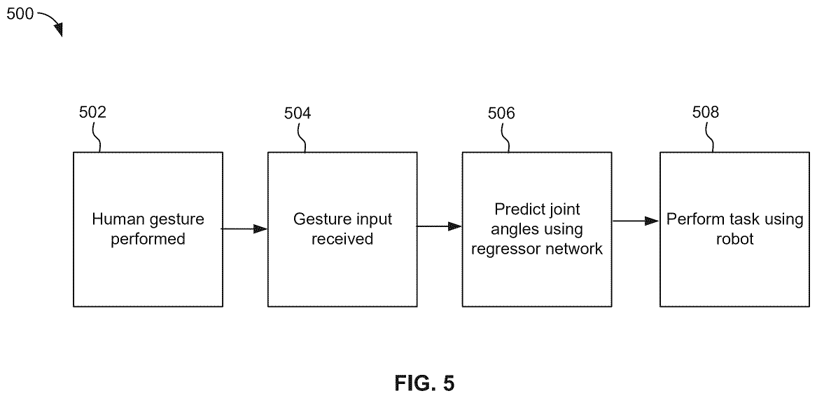

FIG. 5 is a block diagram that depicts an exemplary process flow 500 of a motion intent classifier in accordance with implementations of the present disclosure.

At step 502, the user performs a human gesture. This initial gesture serves as the input for the subsequent processes in the motion intent classifier. In an example, the human gesture may be a victory sign, where the first two fingers of a hand are upright, angled at 30-60 degrees from each other to form a V shape, while the other two fingers and thumb are folded. This gesture, although simple, is composed of complex muscle movements that need to be accurately captured and interpreted to control a robot.

At step 504, the robot controlling system 102 receives a gesture input. In this regard, a capturing device associated with the teleoperator station controller 110 may be utilized to capture the input from the user. The capturing device may be implemented as at least one of a surface electromyography (sEMG) device, a force/pressure sensing device, a motion sensor, and the like. In this regard, the robot controlling system 102 captures at least one electrical signal from at least one input controller, wherein the at least one electrical signal corresponds to the gesture performed by the user. The input controller may be implemented as a device not having any surface electrodes, or as a device having one or more surface electrodes. In an example, the device (when the device does not have any surface electrodes) may be implemented as at least one of a joystick (including force feedback joysticks), a pair of haptic gloves, one or more tactile sensors, one or more vibration motors, an exoskeleton, and the like. In another example, the device (when the device has one or more surface electrodes may be implemented as at least one of an electromyography (EMG) sensor, a biofeedback device, a TENS unit, one or more surface electrode arrays, one or more electrocutaneous devices, and the like.

In an example using the EMG, the user wears the sEMG device on their arm. This device comprises surface electrodes that detect and record the electrical activity generated by the skeletal muscles as the user performs the gesture. The electrical signals captured by the sEMG provide detailed information about the muscle activation patterns, reflecting the specific movements involved in the gesture.

The captured electrical signals are then applied to an artificial intelligence-based motion intent model. This model uses machine learning algorithms to process the electrical signals and extract meaningful patterns that correspond to different gestures. By analyzing the electrical signals, the model can classify the gesture and identify the user's intent behind the gesture. For instance, when the user performs the victory sign, the motion intent model will recognize the specific muscle activation pattern associated with this gesture and label it as a ‘victory’ gesture, determining the user's intent to convey a positive or celebratory action.

At step 506, the robot controlling system 102 predicts the robot joint configurations necessary for performing the task based on the output of the artificial intelligence-based motion intent model. The output of the model, which indicates the labelled action intended by the user, is utilized to generate specific joint configurations for the robot. These joint configurations dictate the precise angles and positions that each joint of the robot must assume to replicate the human gesture accurately.

A regressor network is employed to map the identified action to corresponding robot joint movements. This network takes the labelled action as input and outputs the predicted joint configurations that will enable the robot to perform the gesture. To ensure that these predictions are accurate and reflect the user's true intent, the robot controlling system 102 performs real-time validation using haptic input. The haptic input allows the user to provide feedback and corrections during the robot's movement execution, enabling dynamic adjustments to the joint configurations. For example, if the robot's initial movement does not perfectly replicate the user's intended gesture, the haptic input may be utilized to adjust the joint angles, resulting in an updated robot joint configuration that accurately reflects the user's intent.

At step 508, the updated robot joint configurations are converted into control commands, which are used to perform the task using the robot. The control commands are detailed instructions that the robot's actuators follow to execute the desired movements. These commands are transmitted to the robot station controller 108, which interprets them and directs the robot's actuators accordingly.

Each joint of the robot is equipped with joint controllers that receive specific commands corresponding to their respective movements. For instance, if the task involves replicating the victory sign, the control commands will specify the exact angles and positions for each joint in the robot's fingers to form the V shape. The joint controllers ensure that the robot's joints move smoothly and accurately, following the predetermined trajectory. By executing these control commands, the robot is able to perform the intended task, replicating the human gesture with precision and fidelity. The accurate replication of human gestures allows the robot to interact with its environment in a manner that is natural and intuitive, enhancing its capability to perform tasks that require fine motor skills and human-like dexterity.

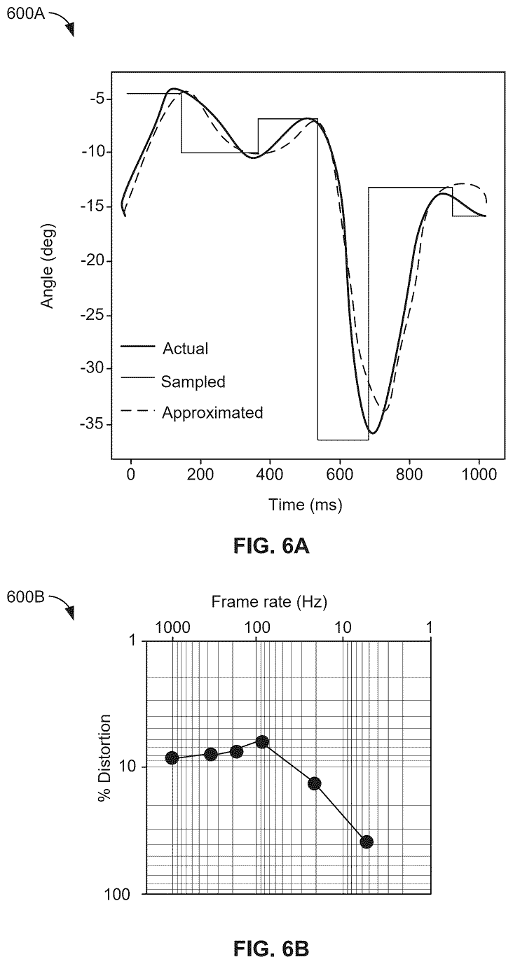

FIG. 6 depicts graphs 600A, 600B representing exemplary experimental information in accordance with implementations of the present disclosure.

FIG. 6A depicts a graph 600A representing experimental information related to the recreation of human gestures, in accordance with implementations of the present disclosure.

In the graph 600A, an actual (human-performed) gesture is represented by a thick solid line, a sampled gesture is depicted by a thin solid line, and an approximated gesture is shown by a dotted line. The actual gesture denotes the representation of the gesture performed by the user. The graph 600A is plotted with respect to angles (or degrees) on the y-axis and time on the x-axis, mapping all representations based on angular positions over a period of time.

The sampled gesture represents data points sparsely sampled from the actual gesture, based on which the approximated gesture is generated. Sparse sampling of data points advantageously reduces the amount of data to be processed, leading to improvements in computational efficiency and savings in storage costs. The actual gesture may be sparsely sampled using a sampling technique that captures key time points in the joint's motion based on the gradient of its motion curve.

The sparse sampling technique may include sampling significant time points where the joint motion changes direction, known as inflection points. This ensures that essential frames are retained for processing. For instance, the algorithm for the sparse sampling technique may select points where there is a notable change in the gradient of the motion curve. An algorithm for the sparse sampling technique is listed hereinbelow.

Initially, the algorithm establishes a set S comprising the start time t=0 and the end time t=T of the motion sequence. Correspondingly, a set G is defined to include the joint angles at these initial and final time points, denoted as θ₀ and θ_{T}, respectively. The algorithm then calculates the gradient ∇θ of the joint angle θ over time to detect significant changes in the motion trajectory.

A critical inflection point z is identified where the gradient's sign changes, indicating a local maximum or minimum in the motion curve. This inflection point is added to the set S. The algorithm proceeds by iterating over the time points in S, beginning from t=0, and for each time point, the corresponding joint angle is added to the set G. The iteration continues until the end time T is reached.

Upon completion, the algorithm returns the sets S and G, which collectively represent the key time points and their associated joint angles, thus preserving the essential characteristics of the joint motion while optimizing the data for further use in robotic teleoperation. This algorithm provides the advantage of significantly reducing the complexity and volume of motion data while retaining all critical aspects of the motion, thereby enhancing the efficiency and effectiveness of subsequent processing tasks.

The approximated gesture refers to the recreated gesture generated from the sampled data points. The sampled data points are interpolated to produce the approximated gesture. As illustrated in the figure, the approximated gesture closely resembles the actual gesture. This approach provides the advantage of fast transfer of control commands for the robot, reduces bandwidth usage by limiting data to sparse samples, and significantly decreases latency in teleoperated robotic systems.

The actual gesture and the approximated gesture are performed, respectively, by the user and the robot, with these representations being visibly seamless. The sampled gesture comprises only a few data points, as exemplified by overlapping lines at specific points such as 5 degrees at 150 ms, 10 degrees at 400 ms, 7 degrees at 550 ms, 36 degrees at 650 ms, and 14 degrees at 950 ms.

FIG. 6B depicts a graph 600B representing experimental data concerning distortion observed relative to frame rate, in accordance with implementations of the present disclosure.

The graph 600B illustrates experimental data points to show a significant reduction in the percentage of distortion of recreated gesture points (i.e., the approximated gesture). The y-axis represents the percentage of distortion, while the x-axis represents frame rate in numerical values. Typically, high distortion levels are observed as the frame rate decreases. However, due to the implementation of sparse sampling, interpolation, and iterative processing functions, the robot controlling system 102 achieves low distortion even with a substantial decrease in frame rate. As shown in the figure, there is an observed distortion of less than 15% even with a frame rate decrease of greater than 70%.

FIG. 7 depicts an exemplary mapping of human gestures onto a robotic arm in accordance with implementations of the present disclosure. The figure consists of three sub-figures FIG. 7A, FIG. 7B, and FIG. 7C, each illustrating different aspects of this mapping process.

FIG. 7A depicts an exemplary representation of measurable joints in a human hand 700A in accordance with implementations of the present disclosure. As shown in the figure, each finger is assigned a digit, such that a thumb is represented with ‘digit 1’, a first finger with ‘digit 2’, a middle finger with ‘digit 3’, a ring finger with ‘digit 4’, and a little finger with ‘digit 5’. Each finger comprises a plurality of joints, which provide a varied range of use to the human/user.

These joints include the carpal joints 13, and 21, the metacarpophalangeal (MCP) joints 5, 8, 10, and 14, which connect the hand to the fingers and allow for flexion and extension, as well as abduction and adduction movements. The proximal interphalangeal (PIP) joints 3, 7, 9, 12, and 16, and distal interphalangeal (DIP) joints 4, 17, 18, 19, and 20, located between the phalanges of the fingers, enable further flexion and extension. Additionally, the thumb includes a carpometacarpal (CMC) joint 1, which facilitates the thumb's unique range of motion, including opposition, enabling the human hand's versatile and dexterous movements. The hand 700A also includes interdigitals/purlicue 2, 6, 11, and 15, which define space between the fingers.

FIG. 7B illustrates an exemplary representation of joints in a robotic hand 700B designed to mimic human hand movements, in accordance with implementations of the present disclosure. The robotic hand includes joints analogous to those in the human hand, such as base joints at the knuckles that allow similar flexion and extension motions. These joints are driven by actuators designed to replicate the fine motor skills of a human hand. The robotic hand also includes joints corresponding to the human hand's MCP, PIP, and DIP joints. Additionally, it features a thumb joint that mimics the human thumb's opposition capability, essential for tasks requiring precise grip and manipulation.

The mapping between the human hand's joints, as shown in FIG. 7A, and the robotic hand's joints, as depicted in FIG. 7B, involves correlating each human joint to a corresponding robotic joint. For example, the MCP joint in the human fingers is mapped to the corresponding base joint in the robotic fingers, allowing the robotic hand to mimic the flexion and extension movements of human fingers. Similarly, the human PIP and DIP joints are mapped to intermediate and tip joints in the robotic hand, respectively, facilitating the replication of intricate finger movements. The human thumb's CMC joint is mapped to a specialized joint in the robotic thumb, designed to reproduce the complex opposition movement characteristic of human thumb functionality.

A mapping of the joints of the human hand 700A to the robotic hand 700B is represented below in Table 1.

TABLE 1
Mapping of the joints of the human
hand 700A to the robotic hand 700B

| | Human hand 700A | Robot hand 700B |
|---|---|---|
| Joint Name | reference | reference |
| Carpal joints | 13 | Little Finger 5 |
| | 21 | Wrist 1 |
| Metacarpophalangeal | 5 | FF Finger 3 |
| joints | 8 | MF Finger 3 |
| | 10 | RF Finger 3 |
| | 14 | LF Finger 3 |
| Proximal | 3 | Thumb 3 and 2 |
| interphalangeal (PIP) | 7 | FF Finger 2 |
| joints | 9 | MF Finger 2 |
| | 12 | RF Finger 2 |
| | 16 | LF Finger 2 |
| Distal interphalangeal | 4 | Thumb 1 |
| (DIP) joints | 17 | FF Finger 1 |
| | 18 | MF Finger 1 |
| | 19 | RF Finger 1 |
| | 20 | LF Finger 1 |
| carpometacarpal | 1 | Thumb 4 and 5 |
| (CMC) joint | | |
| Wrist joint | 22 | Wrist 2 |

FIG. 7C shows exemplary joint configuration limits 700C of the robotic hand in accordance with implementations of the present disclosure. The joint configuration limits detail a range of motion achievable by the robotic hand's joints, indicating the maximum angles for flexion, extension, and other movements. These configuration limits may be essential for ensuring that the robotic hand can perform tasks with precision and without causing damage to itself or the objects it interacts with. The limits are set to mirror the natural range of motion of a human hand, allowing the robotic hand to replicate human-like gestures and movements accurately. For example, as shown in the figure, a minimum angle of movement possible for joints FF1, MF1, RF1, and LF1 is 0 degrees, and a maximum angle of movement possible for the same joints is 90 degrees.

This detailed mapping ensures that the robotic hand can accurately interpret and replicate human gestures, enhancing its ability to perform delicate and precise tasks. By understanding and utilizing the joint configuration limits illustrated in FIG. 7C, the robot controlling system 102 ensures that the robotic hand's movements remain within safe and effective operational boundaries, optimizing both performance and longevity of the robotic components.

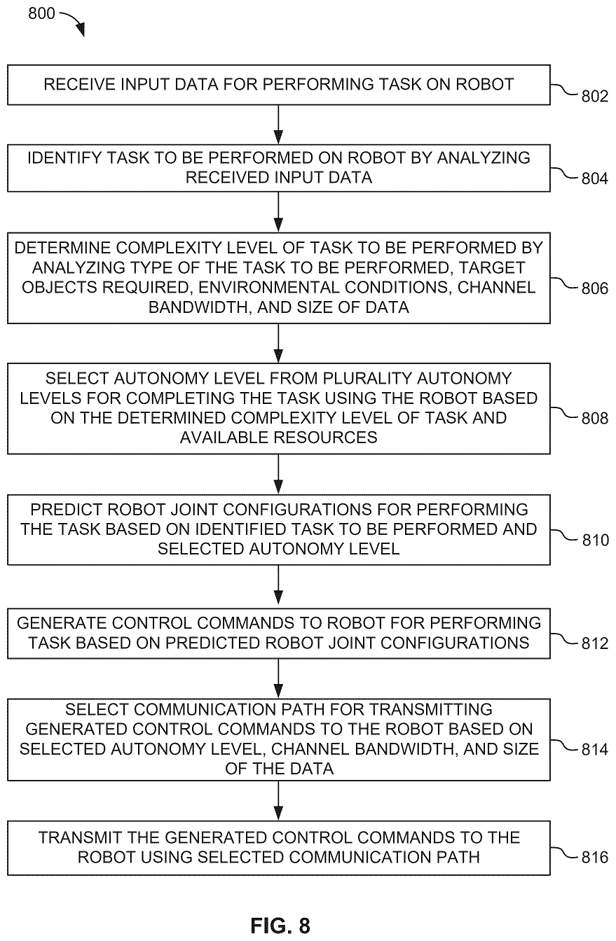

FIG. 8 is a flow diagram 800 that presents an example method in accordance with implementations of the present disclosure. In some instances, the flow diagram 800 presents an example method for providing commands to the robot for performing a task, in accordance with implementations of the present disclosure.

At step 802, input data for performing the task on the robot is received from the user. This input data may include haptic input data (e.g., signals from the EMG), textual input data (e.g., command instructions or task descriptions), telemetry or recording input data (such as video or sensor data from cameras monitoring the robot's actions), and voice input data (e.g., spoken commands). The input data comprises details about the tasks to be performed, specific task requirements, user intent, and any pre-stored instructions. For example, if a user wants the robot to pick up an object, the input data might include a description of the object, its location, and how it should be handled.

At step 804, the task to be performed on the robot is identified. The processor 104 analyzes the received input data to determine the specific task the robot is expected to execute. For example, if the input data includes commands to “pick up the red ball on the table,” the processor identifies this as a task involving object manipulation. This step ensures that the robot understands what it needs to do based on the provided data.

At step 806, the complexity level of the task is determined. The processor 104 evaluates the complexity by considering factors such as the type of task (e.g., simple grasping vs. complex assembly), target objects (e.g., size, weight), environmental conditions (e.g., lighting, obstacles), channel bandwidth (e.g., data transmission capacity), and data size (e.g., amount of data from sensors). For instance, picking up a small, lightweight object may be considered a low-complexity task, while assembling a complex structure from multiple parts would be classified as a high-complexity task.

At step 808, the processor selects an autonomy level from a plurality of autonomy levels (for example, 300A, 300B, or 300C) for completing the task. This selection is based on the determined complexity level of the task and the available resources. The autonomy levels might range from fully manual control (where the user provides direct input) to fully autonomous operation (where the robot performs the task independently). For example, if the task is highly complex and involves uncertain environments, a higher autonomy level with minimal human intervention might be chosen.

At step 810, the processor predicts robot joint configurations necessary for performing the task. This prediction involves determining the specific positions and movements of the robot's joints required to execute the task based on the identified task and the selected autonomy level. For instance, if the task is to reach and grasp an object, the prediction will involve calculating the angles and movements needed for the robot's arm and hand joints to successfully grasp the object.

At step 812, the processor generates control commands for the robot. These commands are derived from the predicted robot joint configurations and include target trajectories and objects. The control commands guide the robot's actuators to achieve the desired movements and interactions. For example, if the predicted joint configuration involves a specific arm movement, the control commands will instruct the robot's actuators to move the arm, accordingly, ensuring that it follows the predicted trajectory to grasp the object.

At step 814, the processor selects a communication path for transmitting the generated control commands to the robot. This selection is based on the chosen autonomy level, channel bandwidth, and data size, ensuring that the control commands are transmitted efficiently. For instance, if the data size is large and requires high-bandwidth communication, a more robust communication path may be selected to ensure timely and accurate command delivery.

At step 816, the processor transmits the generated control commands to the robot using the selected communication path. This step involves sending the commands to the robot to execute the task as specified. For example, if the selected communication path is a wireless network, the control commands are transmitted over the network to the robot, which then performs the task based on the received instructions.

Advantageously, the method 800 optimizes robot task execution by considering task complexity, autonomy levels, and communication efficiency. By accurately predicting joint configurations and tailoring control commands based on input data and task requirements, the method ensures that the robot performs tasks effectively and reliably.

The described methodology provides a technical solution to the challenges of robot control by addressing task complexity and data management. By systematically processing input data, predicting necessary configurations, and selecting optimal communication paths, the method enhances the robot's ability to perform complex tasks with precision and efficiency.

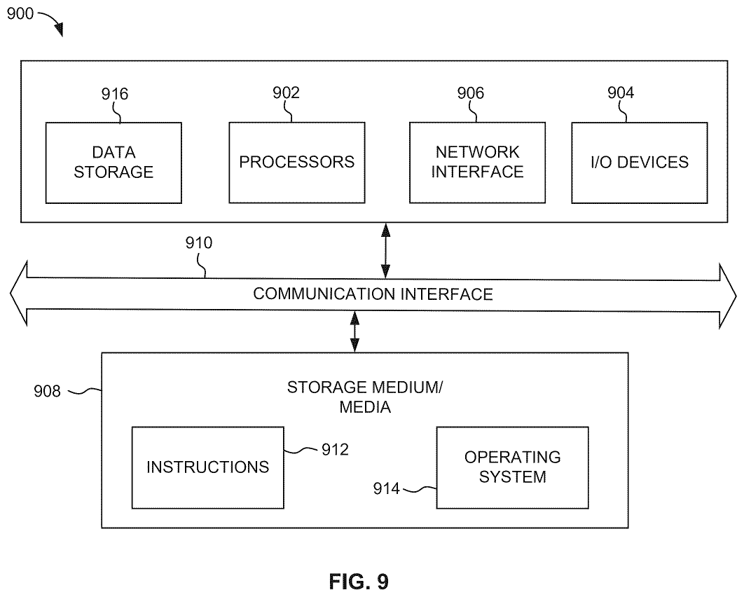

FIG. 9 illustrates a computer system 900 that may be used to implement the robot controlling system 102. More particularly, computing machines such as desktops, laptops, smartphones, tablets, and wearables which may be used to process the conversational interactions in the robot controlling system 102 may have the structure of the computer system 900. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, etc., a network interface 906, such as a Local Area Network (LAN), a wireless 902.11x LAN, a 3G or 4G mobile WAN or a WiMax WAN, and a processor-readable medium 908. These components may be operatively coupled to a communication interface 910 to communicate with a computer-readable medium 908.

The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 708 may include machine-readable instructions 912 executed by the processor(s) 902 that cause the processor(s) 902 to perform the methods and functions of the robot controlling system 102.

The robot controlling system 102 may be implemented as software stored on a non-transitory processor-readable medium and executed by the processors 902. For example, the computer-readable medium 908 may store an operating system 914, such as MAC OS, MS WINDOWS, UNIX, or LINUX, and code for the robot controlling system 102. The operating system 914 may be multi-user, multiprocessing, multitasking, multithreading, real-time, and the like. For example, during runtime, the operating system 914 is running and the code for the robot controlling system 102 is executed by the processor(s) 902.

The computer system 900 may include a data storage 916, which may include non-volatile data storage. The data storage 916 stores any data used or generated by the robot controlling system 102. The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations of the present disclosure introduce significant technical advancements by addressing common inefficiencies in robotic control and motion replication. By leveraging sparse sampling techniques and pre-trained motion dynamic models, the approach ensures that robot motions are precisely aligned with human-like gestures while minimizing data processing requirements. This results in optimized control commands and efficient robot performance. Prioritizing high-fidelity replication of delicate human movements leads to enhanced dexterity and accuracy in robotic tasks, significantly improving the system's overall performance and reducing computational demands. This approach also lessens the dependency on extensive manual adjustments and expert input, which can be time-consuming and may not always achieve optimal results.

Additionally, refining and updating motion replication processes enhance the efficiency of maintaining and upgrading robotic systems. By integrating real-time feedback and continuous adaptation of control commands based on validated joint configurations, the approach minimizes discrepancies between intended and actual robot movements. This advantageously reduces the risk of conflicts and inefficiencies associated with less dynamic systems. Consequently, the modification process becomes more streamlined and effective, improving the accuracy and responsiveness of the robotic system while reducing the need for frequent manual interventions and expert oversight. This leads to reliable performance and reduced time and effort in system updates and adjustments.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them.

The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system 914, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media, and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back-end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive an input data for performing a task on a robot, wherein the input data comprises at least one of a task to be performed, task requirements, a user intent, a haptic input, a text data, a voice data, and a prestored instruction;
identify the task to be performed on the robot by analyzing the received input data;
determine a complexity level of the task to be performed by analyzing the type of the task to be performed, target objects required, environmental conditions, a channel bandwidth, and a size of data;
select an autonomy level from a plurality autonomy levels for completing the task using the robot based on the determined complexity level of the task and available resources;
predict robot joint configurations for performing the task based on the identified task to be performed and the selected autonomy level;
generate control commands to the robot for performing the task based on the predicted robot joint configurations, wherein the control commands comprise the predicted robot joint configurations, target trajectories and the target objects;
select a communication path for transmitting the generated control commands to the robot based on the selected autonomy level, the channel bandwidth, and the size of the data; and
transmit the generated control commands to the robot using the selected communication path.

2. The system of claim 1, further comprising: a robot station controller to:
receive the generated control commands from a teleoperator station controller of the system;
configure robot joint angles based on the received control commands comprising the predicted robot joint configurations, the target objects, and the target trajectories;
generate human-like motions for the robot based on the configured robot joint angles, the target trajectories and the target objects using pre-trained motion dynamic models; and
perform the task on the robot in alignment with the generated human-like motions based on the received input data, the target trajectories, and the selected autonomy level.

3. The system of claim 2, wherein to generate the human-like motions for the robot based on the configured robot joint angles, the target trajectories and the target objects, the robot station controller is to:
generate a plurality of motion dynamic models corresponding to the configured robot joint angles, the target trajectories, and the target objects, wherein the plurality of motion dynamic models correspond to a plurality of bioinspired joint controllers;
determine an optimal performing motion dynamic model from among the plurality of motion dynamic models based on a model performance and relevance to the configured robot joint angles, the target trajectories, and the target objects; and
generate the human-like motions for the robot based on the determined optimal performing motion dynamic model.

4. The system of claim 3, wherein the robot station controller is to:
tune the human-like motions for the robot based on the configured robot joint angles, the target trajectories and the target objects using pre-trained motion dynamic models.

5. The system of claim 1, wherein the processor is to:
remotely control the robot using the robot station controller based on the generated control commands.

6. The system of claim 1, wherein the plurality autonomy levels for completing the task comprises one of a minimal autonomy level, a moderate autonomy level, and a maximal autonomy level.

7. The system of claim 6, wherein the processor is to:
receive the input data as the haptic input from a user for performing the task on the robot;
select the autonomy level as the minimal autonomy level for completing the task using the robot based on the received haptic input; and
transmit the haptic input to the robot using the selected communication path.

8. The system of claim 6, wherein the processor is to:
receive the input data as the haptic input from a user for performing the task on the robot;
identify the task to be performed on the robot by analyzing the received haptic input;
determine the complexity level of the task to be performed by analyzing the type of the task to be performed, the target objects required, the environmental conditions, the channel bandwidth, and the size of data;
select an autonomy level as the moderate autonomy level for completing the task using the robot based on the determined complexity level of the task and available resources;
determine the user intent in completing the task based on an artificial intelligence-based motion intent model;
classify the determined user intent into at least one motion type based on the received haptic inputs and a pre-stored motion table;
generate missing joint configurations for performing the task by mapping the classified motion type to pre-stored joint configurations using one of a robot state machine and a robot behavioral tree;
generate control commands to the robot for performing the task based on the generated missing joint configurations, wherein the control commands comprise the missing joint configurations, the target trajectories, and the target objects;
select a communication path for transmitting the generated control commands to the robot based on the moderate autonomy level, the channel bandwidth, and the size of the data; and
transmit the generated control commands to the robot using the selected communication path.

9. The system of claim 8, wherein to determine the user intent in completing the task based on the artificial intelligence-based motion intent model, the processor is to:
capture at least one electrical signal from at least input controller, wherein the at least one electrical signal corresponds to at least one gesture performed by the user;
apply the captured at least one electrical signal to the artificial intelligence-based motion intent model; and
determine the user intent in completing the task based on an output of the artificial intelligence-based motion intent model, wherein the output indicates labelled action intended by the user for completing the task.

10. The system of claim 6, wherein the processor is to:
receive the input data as at least one of the text data and the voice data from a user for performing the task on the robot;
identify the task to be performed on the robot by analyzing the received voice data using a large language model;
determine the complexity level of the task to be performed by analyzing the type of the task to be performed, the target objects required, the environmental conditions, the channel bandwidth, and the size of data;
select an autonomy level as the maximal autonomy level for completing the task using the robot based on the determined complexity level of the task and available resources;
convert the received voice data to a text-based actions to be performed by the robot for completing the task;
detect the target objects in a field of view, and one of a robot state machine and a robot behavioral tree based on the converted text-based actions using a vision foundational model;
generate the target trajectories for the detected target objects based on the robot state machine, the robot behavioral tree and the converted text-based actions;
predict the robot joint configurations for performing the task by mapping the text-based actions to the generated target trajectories using a generative artificial intelligence model and a machine learning model;
generate the control commands to the robot for performing the task based on the predicted robot joint configurations, wherein the control commands comprise the predicted robot joint configurations, the target trajectories, and the target objects;
select a communication path for transmitting the generated control commands to the robot based on the maximal autonomy level, the channel bandwidth, and the size of the data; and
transmit the generated control commands to the robot using the selected communication path.

11. The system of claim 10, wherein to predict the robot joint configurations for performing the task, the processor is to:
validate the predicted robot joint configurations at real-time using the haptic input; and
generate an updated robot joint configuration for performing the task based on results of validation.

12. The system of claim 1, wherein the processor is implemented as a neuromorphic processor.

13. A method comprising:
receiving, by a processor, an input data for performing a task on a robot, wherein the input data comprises at least one of a task to be performed, task requirements, a user intent, a haptic input, a voice data, and a prestored instruction;
identifying, by the processor, the task to be performed on the robot by analyzing the received input data;
determining, by the processor, a complexity level of the task to be performed by analyzing the type of the task to be performed, target objects required, environmental conditions, a channel bandwidth, and a size of data;
selecting, by the processor, an autonomy level from a plurality autonomy levels for completing the task using the robot based on the determined complexity level of the task and available resources;
predicting, by the processor, robot joint configurations for performing the task based on the identified task to be performed and the selected autonomy level;
generating, by the processor, control commands to the robot for performing the task based on the predicted robot joint configurations, wherein the control commands comprise the predicted robot joint configurations, target trajectories and the target objects;
selecting, by the processor, a communication path for transmitting the generated control commands to the robot based on the selected autonomy level, the channel bandwidth, and the size of the data; and
transmitting, by the processor, the generated control commands to the robot using the selected communication path.

14. The method of claim 13, further comprising:
receiving, by a robot station controller, the generated control commands from a teleoperator station controller of the system;
configuring, by the robot station controller, robot joint angles based on the received control commands comprising the predicted robot joint configurations, the target objects, and the target trajectories;
generating, by the robot station controller, human-like motions for the robot based on the configured robot joint angles, the target trajectories and the target objects using pre-trained motion dynamic models; and
performing, by the robot station controller, the task on the robot in alignment with the generated human-like motions based on the received input data, the target trajectories, and the selected autonomy level.

15. The method of claim 14, wherein generating the human-like motions for the robot based on the configured robot joint angles, the target trajectories and the target objects comprises:
generating, by the robot station controller, a plurality of motion dynamic models corresponding to the configured robot joint angles, the target trajectories, and the target objects, wherein the plurality of motion dynamic models correspond to a plurality of bioinspired joint controllers;
determining, by the robot station controller, an optimal performing motion dynamic model from among the plurality of motion dynamic models based on a model performance and relevance to the configured robot joint angles, the target trajectories, and the target objects; and
generating, by the robot station controller, the human-like motions for the robot based on the determined optimal performing motion dynamic model.

16. The method of claim 13, wherein the plurality autonomy levels for completing the task comprises one of a minimal autonomy level, a moderate autonomy level, and a maximal autonomy level.

17. The method of claim 16, further comprising:
receiving, by the processor, the input data as the haptic input from a user for performing the task on the robot;
selecting, by the processor, the autonomy level as the minimal autonomy level for completing the task using the robot based on the received haptic input; and
transmitting, by the processor, the haptic input to the robot using the selected communication path.

18. The method of claim 17, further comprising:
receiving, by the processor, the input data as the haptic input from a user for performing the task on the robot;
identifying, by the processor, the task to be performed on the robot by analyzing the received haptic input;
determining, by the processor, the complexity level of the task to be performed by analyzing the type of the task to be performed, the target objects required, the environmental conditions, the channel bandwidth, and the size of data;
selecting, by the processor, an autonomy level as the moderate autonomy level for completing the task using the robot based on the determined complexity level of the task and available resources;
determining, by the processor, the user intent in completing the task based on an artificial intelligence-based motion intent model;
classifying, by the processor, the determined user intent into at least one motion type based on the received haptic inputs and a pre-stored motion table;
generating, by the processor, missing joint configurations for performing the task by mapping the classified motion type to pre-stored joint configurations using one of a robot state machine and a robot behavioral tree;
generating, by the processor, control commands to the robot for performing the task based on the generated missing joint configurations, wherein the control commands comprise the missing joint configurations, the target trajectories, and the target objects;
selecting, by the processor, a communication path for transmitting the generated control commands to the robot based on the moderate autonomy level, the channel bandwidth, and the size of the data; and
transmitting, by the processor, the generated control commands to the robot using the selected communication path.

19. The method of claim 18, wherein determining the user intent in completing the task based on the artificial intelligence-based motion intent model comprises:
capturing, by the processor, at least one electrical signal from at least one input controller, wherein the at least one electrical signal corresponds to at least one gesture performed by the user;
applying, by the processor, the captured at least one electrical signal to the artificial intelligence-based motion intent model; and
determining, by the processor, the user intent in completing the task based on an output of the artificial intelligence-based motion intent model, wherein the output indicates labelled action intended by the user for completing the task.

20. The method of claim 16, further comprising:
receiving, by the processor, the input data as at least one of the text data and the voice data from a user for performing the task on the robot;
identifying, by the processor, the task to be performed on the robot by analyzing the received voice data using a large language model;
determining, by the processor, the complexity level of the task to be performed by analyzing the type of the task to be performed, the target objects required, the environmental conditions, the channel bandwidth, and the size of data;
selecting, by the processor, an autonomy level as the maximal autonomy level for completing the task using the robot based on the determined complexity level of the task and available resources;
converting, by the processor, the received voice data to a text-based actions to be performed by the robot for completing the task;
detecting, by the processor, the target objects in a field of view, and one of a robot state machine and a robot behavioral tree based on the converted text-based actions using a vision foundational model;
generating, by the processor, the target trajectories for the detected target objects based on the robot state machine, the robot behavioral tree and the converted text-based actions;
predicting, by the processor, the robot joint configurations for performing the task by mapping the text-based actions to the generated target trajectories using a generative artificial intelligence model and a machine learning model;
generating, by the processor, the control commands to the robot for performing the task based on the predicted robot joint configurations, wherein the control commands comprise the predicted robot joint configurations, the target trajectories, and the target objects;
selecting, by the processor, a communication path for transmitting the generated control commands to the robot based on the maximal autonomy level, the channel bandwidth, and the size of the data; and
transmitting, by the processor, the generated control commands to the robot using the selected communication path.

21. A non-transitory computer readable medium comprising a processor-executable instructions that cause a processor to:
receive an input data for performing a task on a robot, wherein the input data comprises at least one of a task to be performed, task requirements, a user intent, a haptic input, a voice data, and a prestored instruction;
identify the task to be performed on the robot by analyzing the received input data;
determine a complexity level of the task to be performed by analyzing the type of the task to be performed, target objects required, environmental conditions, a channel bandwidth, and a size of data;
select an autonomy level from a plurality autonomy levels for completing the task using the robot based on the determined complexity level of the task and available resources;
predict robot joint configurations for performing the task based on the identified task to be performed and the selected autonomy level;
generate control commands to the robot for performing the task based on the predicted robot joint configurations, wherein the control commands comprise the predicted robot joint configurations, target trajectories and the target objects;
select a communication path for transmitting the generated control commands to the robot based on the selected autonomy level, the channel bandwidth, and the size of the data; and
transmit the generated control commands to the robot using the selected communication path.
